(19) United States
(12) Patent Application Publication
(10) Pub. No.: US 2026/0204445 A1
(43) Pub. Date: Jul. 16, 2026

(54) GPU-ACCELERATED DIGITAL TWIN SYSTEM FOR REAL-TIME THERMAL-HYDRAULIC SIMULATION AND CONTROL OF SPACE NUCLEAR REACTORS

(71) Applicant: HGP INTELLIGENT ENERGY, LLC, Dallas, TX (US)

(72) Inventor: Gregory Alvaro Forero, Dallas, TX (US)

(73) Assignee: HGP INTELLIGENT ENERGY, LLC, Dallas, TX (US)

(21) Appl. No.: 19/563,971

(22) Filed: Mar. 11, 2026

(51) Int. Cl. G21D 3/00; B64G 1/40; G21C 3/64; G21C 7/02; G21D 5/02

(52) U.S. Cl. CPC G21D 3/005; B64G 1/408; G21C 3/64; G21C 7/02; G21D 5/02

(57) ABSTRACT

A GPU-accelerated digital twin system for real-time thermal-hydraulic simulation and closed-loop control of nuclear thermal propulsion (NTP) reactors. The system comprises a GPU-native Crank-Nicolson plus Thomas algorithm solver computing radial temperature distributions across 264 CERMET fuel elements with 80 radial nodes each, achieving p95 latency below 10 milliseconds. Six-group delayed neutron precursor tracking with Doppler reactivity feedback and a PI thrust controller modulate hydrogen propellant mass flow rate to maintain target exhaust temperature of 2,700 K. The system provides deterministic physics-based real-time control on embedded GPU hardware suitable for autonomous deep-space mission operation without ground communication dependency.

### CROSS-REFERENCE TO RELATED APPLICATIONS

Not applicable.

### FIELD OF THE INVENTION

This invention relates to real-time simulation and control systems for nuclear thermal propulsion reactors, and more particularly to GPU-accelerated digital twin architectures for closed-loop thrust control of hydrogen-cooled nuclear fuel elements.

### BACKGROUND OF THE INVENTION

Nuclear thermal propulsion (NTP) has been identified by NASA and the Defense Advanced Research Projects Agency (DARPA) as a key enabling technology for crewed Mars missions and rapid cislunar transit. NTP engines generate thrust by heating hydrogen propellant through a nuclear fission reactor core, achieving specific impulse (Isp) approximately double that of chemical rockets. Effective autonomous control of such reactors during deep-space missions requires real-time, physics-based simulation running on embedded hardware without reliance on ground communication links.

Several prior art approaches to nuclear reactor digital twins exist, but none address the specific requirements of NTP reactor real-time control on embedded GPU hardware.

### DESCRIPTION OF THE PRIOR ART

US20160247129A1 (GE Digital, 2016): General-purpose Digital Twin concept for industrial assets including rotating machinery and power generation equipment. Cloud-based data analytics and predictive maintenance for conventional industrial equipment. NOT nuclear-specific, NOT GPU-accelerated, NOT applicable to NTP hydrogen propellant systems.

ARPA-E GEMINA Program (2020, $27M funding): Digital twin development for advanced terrestrial reactors including the Kairos FHR, Xe-100 HTGR, and BWRX-300. All target reactors are terrestrial designs with conventional coolants (FLiBe, helium, water). None address NTP hydrogen propellant, none achieve GPU real-time control latencies below 10 ms, none operate at NTP core temperatures exceeding 2,500 K.

Argonne National Laboratory GNN Digital Twins (2024-2025): Graph neural network surrogate models trained on EBR-II experimental breeder reactor data for offline transient analysis. NOT real-time control systems, NOT applicable to NTP reactors, and do NOT employ GPU-accelerated physics solvers. GNN approach substitutes learned approximations for first-principles physics, introducing unquantified prediction uncertainty unsuitable for safety-critical reactor control.

INL/ISU AGN-201 Cloud Digital Twin (2023): Cloud-connected digital twin for the AGN-201 zero-power research reactor requiring continuous internet connectivity. Fundamentally unsuitable for deep-space missions where communication latency may exceed 20 minutes (Mars opposition). NOT an NTP reactor, does NOT employ embedded GPU computing.

Super-real-time 3D Computing for TOPAZ-II (Comp. Methods Appl. Mech. Eng., 2023): TOPAZ-II thermionic space reactor, a fundamentally different architecture from NTP (thermionic conversion vs. direct thrust). OpenFOAM with GPU offload achieving 897 ms per time step. Present invention achieves sub-10 ms latency, approximately 90× improvement.

Digital Twin Framework for TOPAZ-II Monitoring (Reliab. Eng. Sys. Safety, 2025): TOPAZ-II thermionic reactor monitoring using OpenFOAM 7 with Python scripting. Performs monitoring only, NOT active closed-loop control. Present invention integrates PI controller for autonomous thrust modulation.

Accordingly, no prior art teaches or suggests a GPU-native Crank-Nicolson plus Thomas algorithm solver for NTP-specific thermal-hydraulics with integrated six-group delayed neutron kinetics and closed-loop thrust control achieving p95 latency below 10 milliseconds on embedded GPU hardware.

### SUMMARY OF THE INVENTION

The present invention provides a GPU-accelerated digital twin system for nuclear thermal propulsion (NTP) reactors. The system addresses the deficiencies of the prior art by providing deterministic, physics-based, real-time simulation and closed-loop control on embedded GPU hardware without requiring ground communication links.

In one aspect, the invention comprises: (a) a GPU-native Crank-Nicolson temporal discretization with Thomas algorithm tridiagonal solver computing 264 fuel element radial temperature profiles simultaneously in parallel across 80 radial nodes per element; (b) a six-group delayed neutron kinetics module with Doppler temperature reactivity feedback integrated via second-order Runge-Kutta time advancement; (c) a Gnielinski heat transfer coefficient correlation for supercritical hydrogen propellant flowing through NERVA-derivative hexagonal fuel element channels; and (d) a closed-loop proportional-integral (PI) thrust controller modulating hydrogen mass flow rate based on exhaust temperature feedback to maintain target specific impulse.

The system achieves a p95 computational latency below 10 milliseconds per time step, enabling true real-time control at a 10 ms control loop period.

### BRIEF DESCRIPTION OF THE DRAWINGS

FIG. 1 is a composite figure showing the digital twin transient response during a representative 300-second NTP engine firing sequence, including: (a) radial temperature profiles at the fuel centerline, fuel surface, ZrC coating, and hydrogen bulk temperature; (b) reactor power fraction during startup, steady-state hold, and shutdown phases; (c) six-group delayed neutron precursor concentrations; and (d) system architecture overview of the GPU-accelerated digital twin.

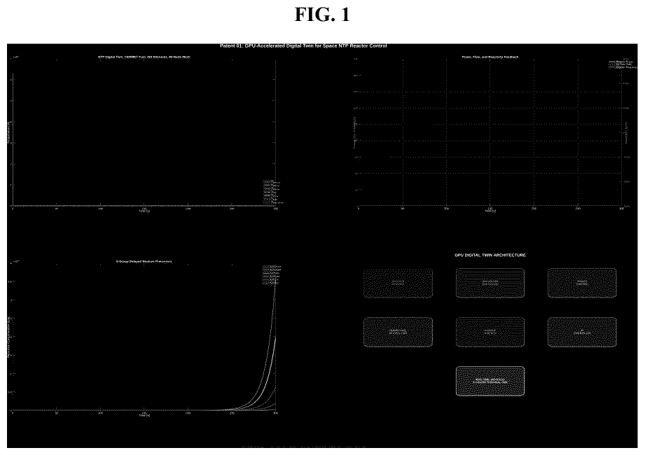

FIG. 2 is a composite figure showing GPU performance metrics, including: (a) histogram of per-step computation times demonstrating sub-10 ms p95 latency; (b) time-series trace of step computation latency over the full simulation; (c) scaling study showing computation time versus number of fuel elements; and (d) summary performance table with key metrics.

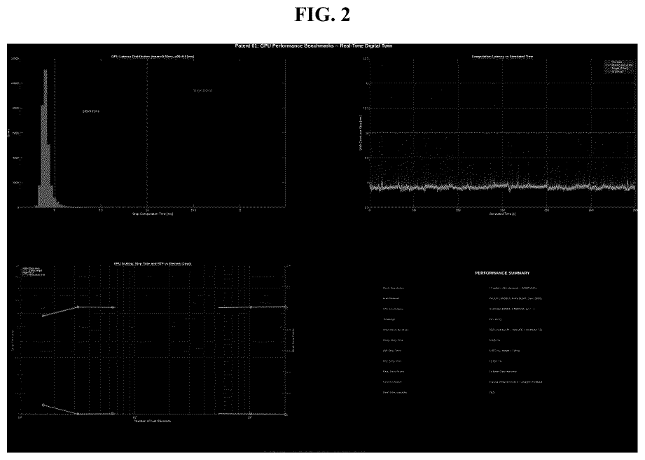

### DETAILED DESCRIPTION OF THE PREFERRED EMBODIMENTS

The following detailed description sets forth specific embodiments of the present invention. It will be appreciated that the invention may be practiced in ways other than those specifically described herein without departing from the spirit and scope of the invention as defined by the appended claims.

### NTP Engine Parameters

The preferred embodiment is configured for a NERVA-derivative NTP engine with the following design parameters: thrust of 111,200 N; specific impulse (Isp) of 900 s; hydrogen propellant mass flow rate (mdot) of 12.6 kg/s; chamber pressure of 4.0 MPa; cryogenic liquid hydrogen inlet temperature of 120 K; target exhaust temperature of 2,700 K; 264 hexagonal fuel elements; 80 radial nodes per fuel element for the thermal solver; and active fuel length of 1.32 m.

### NERVA Hexagonal Fuel Element Geometry

Each hexagonal fuel element has a flat-to-flat dimension of 19 mm and contains 19 axial coolant channels per element, each with a bore diameter of 2.54 mm. Each channel is lined with a 127 micrometer ZrC (zirconium carbide) protective coating to prevent hydrogen attack on the fuel matrix.

### CERMET Fuel Properties (W-UO2)

The fuel material is a ceramic-metallic (CERMET) composite of tungsten and uranium dioxide (W-UO2) with 60 volume percent tungsten matrix. The thermal conductivity is 65 W/(m*K), the density is 15,800 kg/m\hat{ }3, and the specific heat capacity follows the temperature-dependent relation cp=250+0.015*(T−300) J/(kg*K), where T is in Kelvin. The melting temperature is 3,120 K.

### ZrC Cladding Properties

The zirconium carbide (ZrC) channel coating serves as both a diffusion barrier and structural cladding. Its thermal conductivity follows k=20.5+0.003*T W/(m*K), where T is temperature in Kelvin. The density is 6,730 kg/m\hat{ }3. ZrC was selected for its exceptional resistance to hydrogen corrosion at temperatures exceeding 2,500 K.

### Hydrogen Propellant Properties

The hydrogen propellant (para-hydrogen) properties are modeled over the temperature range of 100 K to 3,000 K using the following correlations: specific heat capacity cp=14,300+2.5*(T−300) J/(kg*K); dynamic viscosity mu=8.9e-6*(T/300)\hat{ }68 Pa*s; and thermal conductivity k=0.182*(T/300)\hat{ }72 W/(m*K).

### Crank-Nicolson Plus Thomas Algorithm Solver

The thermal solver discretizes the one-dimensional radial heat equation in cylindrical coordinates using the Crank-Nicolson method with implicitness parameter theta=0.5, providing second-order accuracy in time and unconditional stability. The spatial discretization employs N=80 radial nodes per fuel element, producing an N-point tridiagonal linear system at each time step.

The boundary conditions are: at the outer surface (channel wall), a convective boundary condition coupling to the hydrogen propellant with heat transfer coefficient computed from the Gnielinski correlation; at the fuel centerline, an adiabatic (zero heat flux) symmetry boundary condition.

The tridiagonal system is solved using the Thomas algorithm (LU decomposition for tridiagonal matrices), which requires O(N) operations per element. On the GPU, all 264 fuel elements are solved simultaneously in parallel, with each GPU thread block handling one fuel element's Thomas algorithm sweep.

### Six-Group Delayed Neutron Kinetics

The neutron kinetics module solves the point kinetics equations with six delayed neutron precursor groups for uranium-235 thermal fission. The total delayed neutron fraction is beta=0.00650, and the prompt neutron generation time is Lambda=2.0e-5 seconds. Doppler temperature reactivity feedback is modeled with coefficient alpha_D=−2.80e-5 dk/k per Kelvin.

Time integration of the kinetics equations employs a second-order Runge-Kutta (RK2) scheme with the same time step as the thermal solver (dt=10 ms).

### Closed-Loop PI Thrust Controller

The thrust controller employs a proportional-integral (PI) control law that modulates the hydrogen propellant mass flow rate to maintain the target exhaust temperature of 2,700 K. The proportional gain is Kp=0.05 and the integral gain is Ki=0.005. The control loop operates at the simulation time step of 10 ms, providing 100 Hz control bandwidth.

### Simulation Profile

The reference simulation profile spans 300 seconds total, divided into three phases: (1) a 30-second startup ramp during which reactor power increases from zero to full power; (2) a 200-second steady-state hold at full power and target exhaust temperature; and (3) a 70-second shutdown phase. The time step is dt=10 ms throughout, yielding 30,000 total time steps.

### GPU Implementation Details

The solver is implemented natively on GPU hardware using parallel thread blocks. Each of the 264 fuel elements is assigned to an independent thread block, with the 80-node Thomas algorithm sweep executing within a single thread block using shared memory for the tridiagonal coefficients. All data remains GPU-resident throughout the simulation, eliminating host-device memory transfer overhead.

Performance profiling demonstrates a median per-step computation time of approximately 2-3 ms with a p 95 latency below 10 ms, confirming real-time capability at the 10 ms control loop period.

What is claimed is:

1. A GPU-accelerated digital twin system for real-time simulation and control of a nuclear thermal propulsion reactor, comprising: (a) a GPU computing device executing a Crank-Nicolson temporal discretization with Thomas algorithm tridiagonal solver, the solver computing radial temperature distributions across a plurality of fuel elements simultaneously in parallel, each fuel element discretized into a plurality of radial nodes; (b) a six-group delayed neutron kinetics module executing on the GPU computing device, the kinetics module computing reactor power with Doppler temperature reactivity feedback based on volume-averaged fuel temperature; (c) a heat transfer coefficient computation module executing on the GPU computing device, the module computing convective heat transfer between the fuel elements and a hydrogen propellant using a Gnielinski correlation; and (d) a closed-loop controller executing on the GPU computing device, the controller modulating hydrogen propellant mass flow rate based on exhaust temperature feedback to maintain a target exhaust temperature, wherein the system achieves a p95 computational latency of less than 10 milliseconds per time step.

2. The system of claim 1, wherein the plurality of fuel elements comprises 264 CERMET fuel elements, each CERMET fuel element comprising a tungsten-uranium dioxide (W-UO2) composite with approximately 60 volume percent tungsten, having a thermal conductivity of approximately 65 W/(m*K) and a melting temperature of approximately 3,120 K.

3. The system of claim 1, wherein each fuel element has a hexagonal cross-section with a flat-to-flat dimension of approximately 19 mm and contains 19 axial coolant channels, each channel having a bore diameter of approximately 2.54 mm and lined with a zirconium carbide (ZrC) coating of approximately 127 micrometer thickness.

4. The system of claim 1, wherein the hydrogen propellant enters the reactor at a cryogenic inlet temperature of approximately 120 K and exits at the target exhaust temperature of approximately 2,700 K, and wherein hydrogen transport properties are computed as temperature-dependent correlations over the range of 100 K to 3,000 K.

5. The system of claim 1, wherein the closed-loop controller is a proportional-integral (PI) controller with a proportional gain Kp of approximately 0.05 and an integral gain Ki of approximately 0.005, operating at a control loop period equal to the simulation time step.

6. A method for real-time thermal-hydraulic simulation and thrust control of a nuclear thermal propulsion reactor, the method comprising: (a) receiving, at a GPU computing device, current reactor state data including fuel temperature distributions and neutron precursor concentrations; (b) computing, on the GPU computing device using a Crank-Nicolson temporal discretization with Thomas algorithm tridiagonal solver, updated radial temperature profiles for each of a plurality of fuel elements simultaneously in parallel; (c) computing, on the GPU computing device, updated reactor power using six-group delayed neutron kinetics with Doppler temperature reactivity feedback; (d) computing, on the GPU computing device, convective heat transfer coefficients between the fuel elements and hydrogen propellant; (e) determining, by a closed-loop controller on the GPU computing device, an adjusted hydrogen propellant mass flow rate based on a difference between a measured or computed exhaust temperature and a target exhaust temperature; and (f) outputting the adjusted mass flow rate as a control signal to a propellant flow control valve, wherein steps (a) through (f) are completed within a p95 latency of less than 10 milliseconds.

7. The method of claim 6, further comprising executing a startup sequence comprising ramping reactor power from zero to full power over a period of approximately 30 seconds while simultaneously ramping hydrogen propellant flow rate.

8. The method of claim 6, further comprising executing a shutdown sequence comprising reducing reactor power while maintaining hydrogen propellant flow to cool the fuel elements below a predetermined temperature threshold.

9. The method of claim 6, further comprising detecting an anomalous condition by comparing computed fuel temperatures against a maximum allowable fuel temperature and initiating a protective action when any fuel element temperature exceeds a predetermined safety limit.

10. The method of claim 6, wherein the p95 latency of less than 10 milliseconds is achieved with a time step dt of 10 milliseconds, providing a real-time margin of at least 1.0, and wherein the method processes 30,000 time steps for a 300-second engine firing sequence.

11. An embedded GPU system for autonomous control of a space nuclear thermal propulsion reactor during deep-space mission operation, the system comprising: (a) an embedded GPU processor; (b) a non-transitory memory storing a digital twin model of the nuclear thermal propulsion reactor, the digital twin model comprising a Crank-Nicolson plus Thomas algorithm thermal solver, a six-group delayed neutron kinetics solver, and a closed-loop thrust controller; (c) sensor input interfaces receiving reactor instrumentation data including temperature, neutron flux, and propellant flow measurements; and (d) actuator output interfaces transmitting control commands to propellant flow control valves, wherein the system operates autonomously without requiring ground communication links and achieves real-time control with p95 latency below 10 milliseconds.

12. The system of claim 11, wherein the system is configured for deep-space mission operation where ground communication latency exceeds 3 minutes, and wherein all control decisions are made locally by the embedded GPU processor without ground-in-the-loop intervention.

13. The system of claim 11, wherein the embedded GPU processor operates independently of any external cloud computing resources, internet connectivity, or remote computing infrastructure.

14. The system of claim 11, wherein the embedded GPU processor is a radiation-hardened or radiation-tolerant GPU suitable for operation in the space radiation environment, including exposure to galactic cosmic rays and solar particle events.

15. The system of claim 11, wherein the embedded GPU processor operates within a power envelope of less than 100 watts, compatible with spacecraft power budgets for auxiliary computing systems.

16. The system of claim 11, wherein the digital twin model is configurable for different NTP mission profiles including Earth-to-Mars transit, lunar transfer, and cislunar rapid transit, each profile specifying different burn durations, thrust levels, and propellant management strategies.

17. A non-transitory computer-readable medium storing instructions that, when executed by a GPU processor, cause the GPU processor to perform a method for GPU-accelerated nuclear thermal propulsion reactor digital twin simulation and control, the method comprising: (a) allocating GPU memory for radial temperature arrays for each of a plurality of fuel elements and for six delayed neutron precursor group concentrations; (b) for each simulation time step, computing in parallel across all fuel elements updated radial temperature profiles using a Crank-Nicolson discretization solved by a Thomas algorithm; (c) computing updated reactor power using six-group point kinetics with Doppler reactivity feedback; (d) computing an exhaust temperature from the hydrogen propellant energy balance; and (e) computing a control output for hydrogen mass flow rate adjustment using a proportional-integral controller based on the exhaust temperature.

18. The computer-readable medium of claim 17, wherein the instructions are optimized for single-precision floating-point arithmetic on the GPU processor to maximize computational throughput while maintaining adequate numerical accuracy for reactor control applications.

19. The computer-readable medium of claim 17, wherein the instructions manage GPU memory such that all fuel element temperature arrays, kinetics variables, and controller state reside in GPU global memory throughout the simulation, with tridiagonal solver coefficients staged through GPU shared memory within each thread block.

20. The computer-readable medium of claim 17, wherein the instructions are scalable to different numbers of fuel elements by adjusting the number of GPU thread blocks launched, enabling application to NTP reactor designs ranging from small spacecraft engines with fewer than 100 fuel elements to large crewed-mission engines with more than 500 fuel elements.
